(19) United States
(12) Patent Application Publication
(10) Pub. No.: US 2014/0267415 A1
(43) Pub. Date: Sep. 18, 2014

(54) ROAD MARKING ILLUMINATTION SYSTEM AND METHOD

(71) Applicants: Xueming Tang, Canton, MI (US); Hai Yu, Canton, MI (US)

(72) Inventors: Xueming Tang, Canton, MI (US); Hai Yu, Canton, MI (US)

(21) Appl. No.: 14/205,341

(22) Filed: Mar. 11, 2014

Related U.S. Application Data
(60) Provisional application No. 61/778,336, filed on Mar. 12, 2013.

(51) Int. Cl. G08G 1/16; G06T 11/60

(52) U.S. Cl. CPC G08G 1/16; G06T 11/60
USPC 345/633

(57) ABSTRACT

A controller is configured to enhance driving awareness and safety by recognizing road marking objects and automatically generating laser or light beams to illuminate the road marking objects. The road marking objects are recognized from vehicle surrounding sensing system where cameras are frequently used. The road marking objects are also inferred from navigation information system based on the vehicle's position and knowledge about surrounding environment. Road markings for future vehicle positions are predicted based on present vehicle states and motions. The relative positions of the road marking objects are determined with respect to a vehicle coordinate system. When illuminated from a projector on the vehicle, the projected images of the road markings sufficiently overlap and highlight their target road marking objects on road surface.

### CROSS-REFERENCE TO RELATED APPLICATIONS

This application is a continuation of U.S. Provisional Patent Application Ser. No. 61/778,336

### TECHNICAL FIELD

Various embodiments relate to road vehicle driving assistance system for enhancing driver's awareness of important road markings, road boundary, obstacles and driving processes.

### BACKGROUND

The road marking illumination is a new driving assistance system and augmented reality technology developed for safety and awareness enhancement when driving on road.

Road lane markings, traffic divider blocks and road curbs are critical transportation signals to keep the driver driving safe on road. When such signals get hardly viewable in bad weather condition or in weak lighting environment, the driving experience could be tough and dangerous. Vehicle goes off-road and travels across lanes are dangerous both to the driver and to the neighboring traffics.

The road marking illumination system and method can recognize the most important road marking objects, like lane markings, obstacles, potholes, etc. It then projects virtual objects on the road surface overlaying sufficiently with the real road marking objects to highlight them using laser light beams to enhance their visibility to the driver.

### SUMMARY OF THE INVENTION

The following summary provides an overview of various aspects of exemplary implementations of the invention. This summary is not intended to provide an exhaustive description of all of the important aspects of the invention, or to define the scope of the inventions. Rather, this summary is intended to serve as an introduction to the following description of illustrative embodiments.

In a first illustrative embodiment, a projector on a vehicle if configured to display image on a road surface region around vehicle. A road markings illumination controller is configured to first determine the features and positions of target road marking objects in a vehicle coordinate system and to generate a projection picture containing images for the road marking objects based on their features and positions in the vehicle coordinate system as well as the projection relationship between the position in projection picture frame and the position in the vehicle coordinate system. The controller next project the projection picture using the projector on target road surface region such that the road marking images sufficiently illuminate their target road marking objects.

The projector can be a laser projector with image projected on road surface by laser beams or an optical projector with image project on road surface by light beams. The road marking objects can be road lane markings, road boundary, static and moving obstacles, abnormal surface defects and conditions, etc. In some embodiments, the projection picture further contains road marking images that are obtained based on predicted future vehicle position relatively to the present position of the vehicle coordinate system.

In a second illustrative embodiment, a camera is configured to capture picture of camera view covering a target road surface region around the vehicle. The road markings illumination controller is further configured to at least one of the following functions including: (i) recognize the features and positions of road marking objects in captured camera view picture; (ii) compensate the camera orientation variations with consideration of vehicle body motions; (iii) determine the features and positions of recognized road marking objects in the vehicle coordinate system. This is achieved based on their recognized features and positions in camera picture frame coordinate system and the relationship between the position in camera picture frame and the position in the vehicle coordinate system; and (iv) compensate the position variations of recognized road marking objects in the vehicle coordinate system with consideration of vehicle motions and the time difference between picture capture and picture projection.

Furthermore, the road markings illumination controller is further configured to generate projection picture containing images of road marking objects that are obtained based on at least one of: (i) road marking objects that are interpolated based on other recognized road marking objects; and (ii) road marking objects that are extrapolated based on other recognized road marking objects.

In another illustrative embodiment, a navigation device is configured to obtain the vehicle geographical position and to infer surrounding road marking objects. The road markings illumination controller is further configured to generate projection picture containing images of road markings that are used to illuminate the inferred road marking objects.

In yet another illustrative embodiment, the road markings illumination controller is further configured to generate projection picture containing road markings images using condition based patterns with respect to at least one of environmental lighting condition, weather condition, safety condition and road surface condition.

Additional features and advantages of the invention will be made apparent from the following detailed description of illustrative embodiments.

### BRIEF DESCRIPTION OF THE DRAWINGS

FIG. 1 is a schematic diagram of a vehicle with road marking illumination system for providing enhanced visibility of road marking objects according to one or more embodiments;

FIG. 2 is a method of road marking object projection used by the road marking illumination controller according to one or more embodiments;

FIG. 3 is a method for determining picture view center position in the vehicle coordinate system according to one or more embodiments;

FIG. 4 is a method for vision based positioning according to one or more embodiments;

FIG. 5 is a method of the vision based positioning process to determine the locations of road marking objects recognized in the camera picture frame according to one or more embodiments;

FIG. 6 is a method for compensating time difference resulted position displacements according to one or more embodiments;

FIG. 7 is a diagram for interpolating and extrapolating road lane markings based on their consecutive recognized lane markings according to one or more embodiments;

FIG. 8 is a diagram for the method of inferring road marking objects from navigation and information center according to one or more embodiments;

FIG. 9 is a method for future vehicle path prediction used in road marking illumination according to one or more embodiments;

FIG. 10 is an exemplary embodiment of the road marking illumination pattern used for vehicle safe spacing warning;

### DETAILED DESCRIPTION OF THE INVENTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The present invention discloses system, methods and apparatus for a new driving assistance system using augmented reality technology for safety and awareness enhancement when driving on road. Road marking object recognition and augmentation are used as the primary embodiment to illustrate the system and methods for road markings illuminations.

With reference to FIG. 1, a vehicle with road marking illumination system for providing enhanced visibility of road marking objects is illustrated in accordance with one or more embodiments and is generally referenced by numeral 10. The vehicle 14 is equipped with at least one projector device 18 that can display picture by scanning the road surface with laser or light beams at very high speed and frequency. Based on the projector type and installation method, a projector has a specific projection region on road surface around the vehicle 14.

Using the vehicle body frame as the reference coordination system, a vehicle coordinate system 52 is defined relatively to the vehicle body at the vehicle's instantaneous position. Exemplary embodiment of the vehicle coordinate system is three dimensional Cartesian coordinate system with three planes, X-Y, X-Z and Y-Z, perpendicular to each other. A position in the vehicle coordinate system 52 has unique coordinates (x,y,z) to identify where it is relatively to the vehicle. The origin of the vehicle coordinate system is at the center of the front side of the vehicle with the X-axis pointing forwardly to the vehicle driving direction and the Z-axis pointing vertically upwards. The vehicle coordinate system is a moving coordinate system and all surrounding road marking objects have a position in the vehicle coordinate system relatively to the instantaneous geographical position of the vehicle 14. Such a vehicle coordinate system 52 innovatively integrate the picture projection subsystem, surrounding sensing subsystem and vehicle motion system seamlessly in order to achieve a high quality and accurate road marking object illumination function.

Based on the position of projector 18 in the vehicle coordinate system (xₚ, yₚ, zₚ) and its orientation angles, the projection region on the road surface and its geometric and projection relationships to the projection picture frame coordinate system can be determined. Such geometric and projection relationships are important for transforming a target road marking object from its position in the vehicle coordinate system to a corresponding picture frame position in the project picture such that the image of the road marking object, when projected on the road surface, sufficiently overlaps the target road marking object and highlight it. Furthermore, such relationships are also important for system calibration and re-adjustment to assure projection accuracy with respect to image distortion and vehicle body motions.

In FIG. 1, an exemplary road marking object 34 is represented by road lane markings on the road surface in front of the vehicle driving direction. A point M 56 on the road marking object 34 has position coordinates (xₘ, yₘ, zₘ) in the vehicle coordinate system 52. zₘ=0 is typically used when the ground is defined as the origin of the Z-axis. Based on the position of the road marking objects 34 in the vehicle coordinate system, the positions for images of the road marking object on the projection picture can be determined based on coordinate transformation between the vehicle coordinate system and the projection picture frame coordinate system. This task is achieved by a road marking illumination control 22. By sketching road marking objects at corresponding shape and size and at corresponding position on the projection picture, the projection picture, after projected onto the road surface, displays road marking illumination image 38 that sufficiently overlaps and highlights the real road marking objects 34.

Besides road lane markings, typical road marking objects also include road boundary, static and moving obstacles, road surface defects and conditions, and safe driving margins, etc. In order to illuminate road marking objects correctly on road surface, recognition of their presence, features and position are critical in the road marking illumination system 10. The road marking object recognition is primarily achieved using vehicle surrounding sensing systems 26. Different types of surrounding sensing devices can be used and they include range scanning LIDAR, sonar, radar and cameras. This specification focus on camera as exemplary embodiment for the surrounding sensing system. The usage of other types of surrounding sensing devices is similar to that of the camera for the road marking illumination system and they can also be used together with the camera.

A camera 26 captures picture of view covering the road surface region of interested. Road marking objects presented in the camera picture are recognized by the road marking illumination controller together with identified features and positions of them. The features include at least the shape and size parameters of the recognized road marking objects. The positions include both their positions in the picture frame coordinate system and their positions transformed to the vehicle coordinate system. In an exemplary embodiment, the features of a road marking object are represented by characteristic points on the object such that their size and shape can be constructed for their images on the projection picture by tracing all their characteristic points at corresponding positions in the project image frame coordinate.

The road marking object recognition can secondarily be obtained from navigation and information center 30. The navigation and information center 30 stores important road marking object information about their features and their geographical positions. It can also determine the instantaneous geographical position of the vehicle. As a result, the relative positions of the road marking objects in the vehicle coordinate system can be inferred from the position differences between the stored road marking objects' position and the determined vehicle position. Together with the stored feature information including the shape and size of the road marking objects, their images can be sketched in the projection picture at picture frame positions corresponding to their relative positions to the vehicle.

The vehicle's future positions in the present vehicle coordinate system can be predicted based on the present vehicle states including vehicle speed and yaw rate. The predicted future positions up to a time range T construct a predicted vehicle path trajectory in the vehicle coordinate system. This future vehicle path is another type of road marking object. By sketching images for the future vehicle path in the projection picture at their corresponding picture frame trajectory, the projected vehicle path tells the driver how the current driving process aligns to the curvature of the road.

With reference to FIG. 2, a method of road marking object projection process used by the road marking illumination controller is illustrated in accordance with one or more embodiments and is generally referenced by numeral 100. After starting at step 104, the process checks if there is new road marking object to be illuminated by the system. If yes, the method next obtains feature information about the new road marking object as well as its representing positions in the vehicle coordinate system at step 116. The features of a road marking object include its shape and size. In an exemplary embodiment, the features of a road marking object are represented by a sequence of characteristic points along the boundary of the road marking object and each characteristic point has its position coordinates in the vehicle coordinate system. If no at step 108, the method 100 continues to step 124.

At step 120, an image of the new road marking object is sketched and appended to the existing projection picture. First, using the coordinate transformation method, the positions of the characteristic points of the road marking object in the projection picture frame coordinate can be determined based on their original positions in the vehicle coordinate system. Next, by tracing the characteristic points in the projection picture frame, the image for the road marking object is constructed on the projection picture. Images for road marking objects are removed from the projection picture if their corresponding road marking objects no longer need to be illuminated.

At step 124, updates on features and positions of existing road marking objects are obtained. Similar to step 120, images for the existing road marking objects are re-sketched on the projection picture based on their updated features and position in the vehicle coordinate system. At step 128, the projector 18 scans the road surface using laser or light beams to display the projection image on the road surface. The projected images of the road marking objects thus sufficiently overlap and illuminate their target road marking objects on the road surface because the unique one-to-one position relationship between the projection image frame and the road surface region in the vehicle coordinate system. The method continues at step 132 with a new iteration of the process 100 after step 128 is finished.

For the road marking object illumination system 10 and method 100, the determination of the position transformation relationship between a picturing frame coordinate system for devices 18 and 26 and the vehicle coordinate system is one of the key technologies to realize the road marking object illumination function. With reference to FIG. 3, a method for determining picture view center position in the vehicle coordinate system is illustrated in accordance with one or more embodiments and is generally referenced by numeral 200. This method can be used for both the view picture capturing device and the road picture projection device. This method and the vision based positioning method together provide the fundamental coordinate transformation relationship between the device orientation and the position of the picture frame center in the vehicle coordinate system.

First, device orientation determines the direction of the picturing line-of-sight 216 and subsequently determines the position of aim-point 220 in the vehicle coordinate system 52. The device 204 has a position coordinates (x_{d}, y_{d}, z_{d}) in the vehicle coordinate system and it has a picture view region 232 on the road surface. Based on the height zₒ of the road surface 236, the height of the device above the road surface 236 is: h_{d}=z_{d}−zₒ. According to the device's orientation, the device's heading angle a 208, overlook angle β 212 and picture rotation angle γ 240 can be determined. The horizontal distance between the device and the device aim-point 220 on the ground can be computed as: lₓ=h_{c} cos α/tan β denoted by numeral 224 and l_{y}=h_{c} sin α/tan β denoted by numeral 228. The interception point of the device line-of-sight 216 on the road surface 236 is the aim-point 220 at location (x_{sc}, y_{sc}, z_{sc}) where the device aim-point position in the vehicle coordinate system 52 is determined by:

(x_{sc},y_{sc},z_{sc})=(x_{d}+lₓ,y_{d}+l_{y},zₒ) (1)

Equation (1) is used to determine the device's picturing center position in the vehicle coordinate system.

After a device's picture center position is known, the positioning relationship between the device's picture frame coordinate system and the vehicle coordinate system can then be determined using coordination transformation method. This process is called vision based positioning method. An exemplary embodiment of the vision positioning technique applies 3D projection method to establish coordinate mapping between the three-dimensional vehicle coordinate system 52 to a two-dimensional device picture frame coordinate system 232.

With reference to FIG. 4, a method for vision based positioning is illustrated in accordance with one or more embodiments and is generally referenced by numeral 260. In the presentation of the proposed invention, perspective transform is used as exemplary embodiment of the 3D projection method. A perspective transform formula is defined to map coordinates between 2D quadrilaterals. Using this transform, a point in the first quadrilateral surface (P, Q) can be transformed to a location (M, N) on the second quadrilateral surface using the following formula:

$$( M , N ) = {Φ}_{12} = ( \frac{aP + bQ + c}{gP + hQ + 1} , \frac{dP + eQ + f}{gP + hQ + 1} ) \qquad ( 2 )$$

The parameters a, b, c, d, e, f, g, h are constants whose value are determined with respect to selected quadrilateral area and surface to be transformed between the two surfaces in different coordinate systems. Φ₁₂ defines the coordinate transformation relationship from the first coordinate system to the second coordinate system. For the device 204, different sets of parameter values for equation (2) are used at different device's aim-point position 220 in the vehicle coordinate system 52.

For the projector 18, the picture frame coordinate system 264 defines the projection picture frame coordinate system and the road surface region 232 in the vehicle coordinate system defines the projection region on the road surface. The coordinate transformation relationship Φᵥₚ defined using equation (2) determines the formula that converts a position in the vehicle coordinate system (x, y) within road surface region 232 to a position in the projection picture frame coordinate system (X, Y). The coordinate transformation relationship Φᵥₚ is primarily used at step 120 of method 100 in sketching image for a road marking object in the projection picture based on the road marking object's characteristic points in the vehicle coordinate system. According to the projection relationship between the projection picture and the road surface, the resulted illumination image of the road marking object projected on the road surface will effectively overlap its target road marking object on road surface.

For the camera 26, the picture frame coordinate system 264 defines the captured camera view picture frame coordinate system and the road surface region 232 in the vehicle coordinate system defines the camera view region on the road surface. The coordinate transformation relationship Φ_{cv} defined using equation (2) determines the formula that converts a position in the camera picture frame coordinate system (X, Y) to a position in the vehicle coordinate system (x, y) within the road surface region 232. The coordinate transformation relationship Φ_{cv} is primarily used to identify the positions of recognized road marking objects in the vehicle coordinate system based on their recognized positions in the captured camera view picture frame coordinate system.

With reference to FIG. 5, a method of the vision based positioning process to determine the locations of road marking objects recognized in the camera picture frame is illustrated in accordance with one or more embodiments and is generally referenced by numeral 300. The process starts at step 304. While capturing a picture frame from the camera, the present camera orientation angles (α,β,γ) are obtained at step 308. Based on the camera orientation aim-point 220 in the vehicle coordinate system, calibrated coordinate transformation formula Φ_{cv}(α,β,γ) and its parameter set at the present orientation angles are loaded from a database at step 312 to convert positions identified in the camera frame coordinate system to corresponding positions in the field coordinate system. The values for different parameter sets are predetermined at different calibration states of (α,β,γ). It is important to point out that besides the normal camera device orientation variations, the (α,β,γ) orientation based coordinate transformation relationships are also used to compensate orientation deflection introduced by vehicle body's pitch and roll motion, which primarily changes the overlook angle β 212 and picture rotation angle γ 240, respectively. Based on the measured or estimated vehicle pitch angle and body roll angle, the instantaneous camera overlook angle β 212 and picture rotation angle γ 240 can be determined by adding the additional vehicle body motions to the normal camera device orientation angles. The final determined overlook angle β 212 and picture rotation angle γ 240 of the camera device is then used to retrieve parameter set for instantaneous coordinate transformation formula Φ_{cv} (α,β,γ). Similar vehicle body pitch and roll motion compensation method is also used in generating projection picture for determining parameter value set for Φᵥₚ (α,β,γ) based on the projector's instantaneous orientation angles combining normal projector orientation angles and the vehicle body pitch and roll angles.

Next, road marking objects are identified in the picture frame with a sequence of object characteristic points identified for each of them. Such a characteristic point sequence portraits the features of a road marking object like shape and size. The positions of the object characteristic points are obtained in the camera frame coordinate at step 316. The positions of the object characteristic points in the vehicle coordinate system are then derived at step 320 using the coordinate transformation formula Φ_{cv} (α,β,γ) and parameters at loaded step 612. The feature and position of each road marking object in the vehicle coordinate system are then determined at step 324. After that, the process continues at step 328 with a new iteration of the method 300.

In the road marking object illumination system, the road marking projection step is always after the road marking recognition step, especially for the embodiments of the system that involve vision based road marking object positioning process. There is a small time difference Δt between the moment of camera picture capture and the moment of projector picture projection. Due to vehicle motions and subsequent vehicle coordinate system movements, the relative position of a road marking object to the vehicle naturally deflects from its recognized position in the vehicle coordinate system from the visioning based positioning process. Such position displacements needs to be compensated especially in determining the position of images of road marking objects in the projection picture at step 120.

With reference to FIG. 6, a method for compensating time difference resulted position displacements is illustrated in accordance with one or more embodiments and is generally referenced by numeral 400. After the method starts at step 404, vehicle motion states are obtained at step 408. Important vehicle states include vehicle longitudinal speed vₓ, vehicle lateral speed v_{y} and vehicle yaw rate r. Vehicle body roll rate p and pitch rate q can also be used. Meanwhile, the time difference Δt between the camera picture capture time instant and the future projector picture projection instant is estimated based the processing status of the controller 22. At step 412, the vehicle coordinate system's displacements are determined. The translational displacements are: (sₓ, s_{y})=(vₓΔt, v_{y}Δt) and the rotational displacements are: (θ, φ, ξ)=(rΔt, pΔt, qΔt). sₓ and s_{y} are the vehicle's displacements in the longitudinal direction and lateral direction, respectively. θ is the vehicle yaw angle in Δt time duration. φ and ξ and the roll angle and pitch angle, respectively. Since Δt is quite small, the first order estimation of the vehicle displacements is sufficient. More accurate estimation may further require vehicle accelerations and angular acceleration states.

As the vehicle moves from its present position to a new position in Δt time interval, so is the vehicle coordinate system defined with respect to the vehicle body frame. For convenience, the vehicle coordinate system at the camera picture capture moment is called VCS1 and the future vehicle coordinate system at the projector projection moment is called VCS2. The positions of road marking objects recognized using VCS1 from the vision based positioning process need to be transformed to their corresponding positions in VCS2 in order to be projected back on the same position on the road surface correctly. At step 416, a 3D coordinate transformation formula and associated parameter values are determined for coordinate transformation from VSC1 to VSC2 and it is defined by Ψ₁₂. Using vehicle translation motion and yaw motion as example, the 3D coordinate transformation from a position (x₁, y₁, z₁) in VSC1 to a position (x₂, y₂, z₂) in VSC1 is:

$$[ \begin{matrix}{x}_{2} \\ {y}_{2} \\ {z}_{2} \\ 1\end{matrix} ] = {Ψ}_{12} [ \begin{matrix}{x}_{1} \\ {y}_{1} \\ {z}_{1} \\ 1\end{matrix} ] = [ \begin{matrix}cos θ & - sin θ & 0 & {s}_{x} \\ sin θ & cos θ & 0 & {s}_{y} \\ 0 & 0 & 1 & 0 \\ 0 & 0 & 0 & 1\end{matrix} ] [ \begin{matrix}{x}_{1} \\ {y}_{1} \\ {z}_{1} \\ 1\end{matrix} ] \qquad ( 3 )$$

Vehicle vertical motion displacement is ignored in this exemplary embodiment.

Next at step 420, the positions of characteristic point for all the road marking objects obtained at step 320 in method 300 need to be transformed from VSC1 to VSC2 using the coordinate transformation formula in equation (3) and the determined displacements sₓ, s_{y}, θ. After that, the new positions in VSC2 for all the road marking objects are used to construct images for them in the projection picture at step 424. The method 400 ends at step 428 and it continues with a new iteration in a new camera picture capture to projector picture projection loop.

For certain road marking objects, especially road lane markings, faded lane marking paints due to lack of maintenance and blocked lane markings covered by sand, water or snow cannot be recognized from vision based road marking object recognition method. These missing road marking objects have to be inferred from recognized similar road marking objects based on continuity property or other knowledge about them. Using road lane markings as an exemplary embodiment, missing road lane markings can be interpolated or extrapolated from recognized road markings before and after the missing sections. A totally missing long section of road lane markings can be inferred through a parallel trajectory to recognized road boundaries or to a recognized road marking trajectory from neighboring road lanes.

With reference to FIG. 7, a diagram for interpolating and extrapolating road lane markings based on their consecutive recognized lane markings is illustrated in accordance with one or more embodiments and is generally referenced by numeral 500. Frist, features and positions for existing and viewable road lane marking lines 504 are recognized using the vision based positioning method 300. Given a series of position pairs (xᵢ, yᵢ), i=1,2,3, . . . , for all the characteristic points of the recognized road lane marking lines, a polynomial function y=f (x) can be determined and this function models the trajectory of the lane behind the road lane markings An exemplary method for solving function f(x) is using Lagrange's formula, which predicts the value of the polynomial of order M−1 passing through M points (xᵢ, yᵢ) at a separate given point x is:

$$f ( x ) = {\sum }_{i = 1}^{M} {y}_{i} ( \frac{{\prod }_{j \neq i} ( x - {x}_{i} )}{{\prod }_{k \neq i} ( {x}_{i} - {x}_{k} )} ) \qquad ( 4 )$$

Then a curve on the X-Y plane of the vehicle coordinate system 52 can be obtained and plotted based on equation (4) and the known positions of characteristic points (xᵢ, yᵢ) of all the recognized road lane markings. This curve is called polynomial approximated lane trajectory 508. Based on this curve, positions and features of the missing lane marking lines can be determined and interpolated lane markings 516 are thus constructed between recognized sections of lane markings 512. When the missing lane markings happen beyond the end of the recognized lane marking sections, extrapolation has to be used based on the polynomial approximation curve 508. Based on the approximation confidence evaluated from the ratio of known road markings vs. missing road markings and the road curvature smoothness, an extrapolation rang 520 is first determined. The higher the confidence, the longer the range. Within the allowable extrapolation range 520, missing lane marking lines are positioned based on the coordinates of points along the polynomial approximation curve 508. As a result, extrapolated lane markings 524 are obtained together with their determined features and positions in the vehicle coordinate system. The finalized road lane marking trajectory is complete and smoothly following the road curvature. The road lane marking trajectory is next sketched in the projection picture for displaying and highlighting the road lane markings in front the vehicle traveling direction.

For road marking objects that are not viewable for the surrounding sensing devices 26, their position and feature in the vehicle coordinate system can alternatively inferred based on the data obtained from the navigation and information center 30. With reference to FIG. 8, a diagram for the method of inferring road marking objects from navigation and information center is illustrated according to one or more embodiments and it is depicted by 600. First, a road marking object 604 is retrieved from the navigation and information center 30 together with its characteristic points and their positions in the global geographical coordinate system 612. In the exemplary embodiment, the road marking object 604 has four characteristic points 608 and their global position coordinates are (Pᵣₒᵢ, Qᵣₒᵢ), for i=1,2,3,4. Second, the instantaneous vehicle position in the global geographical coordinate system is determined by the navigation system 30 as (Pᵥ, Qᵥ). The vehicle orientation angle with respect to the global coordinate system is δ. The position of the first characteristic point of the road marking object 604 in the vehicle coordinate system is thus determined by the road marking illumination controller 22 as:

$$[ \begin{matrix}{x}_{roi} \\ {y}_{roi}\end{matrix} ] = [ \begin{matrix}cos δ & - sin δ \\ sin δ & cos δ\end{matrix} ] [ \begin{matrix}{P}_{ro 1} - {P}_{v} \\ {Q}_{ro 1} - {Q}_{v}\end{matrix} ] \qquad ( 5 )$$

Using equation (5), the positions for all the characteristic points in the vehicle coordinate system can be determined and thus the road marking object is specified for the road marking illumination controller. In applications, the position in global coordinate system may be represented by coordinates of longitude and latitude. In this case, additional coordinate transformation is needed.

Vehicle future path is a type of road marking object that is not available from the road surface view. Vehicle future path is predicted based on present vehicle state and vehicle operation inputs from the driver. In order to illuminate future vehicle path on the road surface, future vehicle positions are to be predicted with respect to the present vehicle coordinate system. With reference to FIG. 9, a method for future vehicle path prediction used in road marking illumination is illustrated according to one or more embodiments and it is depicted by 700. After start at step 704, the method 700 obtains the present vehicle states including vehicle longitudinal speed vₓ(0), lateral speed v_{y}(0) and yaw rate r(0) . The method also obtains the inputs to the vehicle including longitudinal acceleration aₓ(0) and vehicle steering input δₛ(0) at step 708. It sets the prediction step k=0. The vehicle path prediction process starts from k=1 at step 712. At each entry of step 712, the prediction step indicator k is added by one. There is a δt time interval between consecutive prediction steps. At step 716, the prediction step k is next compared with a predetermined input horizon h₁, which specifies how many steps into the future time horizon that the initial inputs to the vehicle system shall be used. If k>h₁, the inputs to the vehicle system are set to aₓ=0 and δₛ=0 at step 720. Otherwise, the inputs to the vehicle system are set to aₓ=aₓ(0) and δₛ=δₛ(0) at step 724. Based on the vehicle states at the (k−1)-th prediction interval, the vehicle state at the k-th prediction interval is evaluated at step 728 using a linearized vehicle model as:

$$[ \begin{matrix}{v}_{x} ( k ) \\ r ( k ) \\ {β}_{v} ( k )\end{matrix} ] = [ \begin{matrix}0 & 0 & 0 \\ 0 & 1 + \frac{δ t ( - {l}_{f}^{2} {c}_{f} + {l}_{r}^{2} {c}_{r} )}{{I}_{z} {v}_{x} ( k )} & \frac{δ t ( {l}_{r} {c}_{r} - {l}_{f} {c}_{f} )}{{I}_{z}} \\ 0 & δ t + \frac{δ t ( {l}_{r} {c}_{r} - {l}_{f} {c}_{f} )}{{mv}_{x} ( k )} & 1 + \frac{δ t ( - {c}_{f} + {c}_{r} )}{{mv}_{x} ( k )}\end{matrix} ] + δ t [ \begin{matrix}1 & 0 \\ 0 & \frac{{l}_{f} {c}_{f}}{{I}_{z}} \\ 0 & \frac{{c}_{f}}{{mv}_{x} ( k )}\end{matrix} ] [ \begin{matrix}{a}_{x} \\ {δ}_{s}\end{matrix} ] \qquad ( 6 )$$

In equation (6), parameter l_{f} and lᵣ are the distance from vehicle center of gravity to its front and rear axles, respectively. Parameters c_{f} and cᵣ are the cornering stiffness of the vehicle front axle and rear axle, respectively. m is vehicle mass and l_{z} is the vehicle turning inertia around vertical axis. Variable βᵥ=v_{y}/vₓ. Thus, at the k-th iteration, the lateral speed is obtained as v_{y}(k)=βᵥ(k)vₓ(k).

Next, based on the predicted vehicle future states, the vehicle future positions (x, y) in the vehicle coordinate system can be estimated at step 732 as:

$$\begin{matrix}θ ( k ) = θ ( k - 1 ) + r ( k ) δ t & ( 7 ) \\ [ \begin{matrix}x ( k ) \\ y ( k )\end{matrix} ] = [ \begin{matrix}x ( k - 1 ) \\ y ( k - 1 )\end{matrix} ] + [ \begin{matrix}cos θ ( k ) & - sin θ ( k ) \\ sin θ ( k ) & cos θ ( k )\end{matrix} ] [ \begin{matrix}{v}_{x} ( k ) δ t \\ {v}_{y} ( k ) δ t\end{matrix} ] & ( 8 )\end{matrix}$$

After step 732, the method 700 checks on if the predefined prediction horizon has been reached by k>h₂, where T=h₂δt. Before the h₂ prediction steps are reached, the process switches back to step 712 with a new iteration of the position prediction computation. Otherwise, the method 700 stops at step 740. By connecting all the derived future vehicle positions at h₂-steps of prediction, a future vehicle path is constructed in the present vehicle coordinate system.

The road marking illumination controller 22 also controls the illumination patterns used for road marking objects especially for safety warning types of road markings. With reference to FIG. 10, an exemplary embodiment of the road marking illumination pattern used for vehicle safe spacing warning is illustrated and it is depicted by 800. In this example, a preceding vehicle 804 is in front of vehicle 14 in its driving direction. For vehicle 14, a safe spacing distance Cₛ 820 is expected to be kept after the preceding vehicle 804. When the real vehicle spacing C_{c} 824 is less than Cₛ 820, a safety warning road marking object 808 is generated by the road marking illumination controller 22 at corresponding position after the preceding vehicle. When projected by projectors 18 on the road surface, the safe spacing warning road marking 808 alerts the driver of the insufficient vehicle spacing between vehicles. A displaying pattern can be used for sketching warning markings 808 depending on the severity level. For example, the more severe the current vehicle spacing situation, the more number of warning bars 816 are used for the safe spacing warning road marking object 808 and the thicker each warning bar is sketched for a width parameter Pᵢ 812. FIG. 10 provides an exemplary case for applying patterns of road marking illumination to achieve additional illumination effects. In application, different condition based illumination patterns can be applied with respect to environmental lighting condition, weather condition, safety condition and road surface condition, etc. This method is useful when the original shape and size of the road marking object are not important in the illumination results.

As demonstrated by the embodiments described above, the methods and apparatus of the present invention provide advantages over the prior art by enabling automatic object initialization and targeting in activity field before a target object has been specified.

While the best mode has been described in detail, those familiar with the art will recognize various alternative designs and embodiments within the scope of the following claims. Additionally, the features of various implementing embodiments may be combined to form further embodiments of the invention. While various embodiments may have been described as providing advantages or being preferred over other embodiments or prior art implementations with respect to one or more desired characteristics, those of ordinary skill in the art will recognize that one or more features or characteristics may be compromised to achieve desired system attributes, which depend on the specific application and implementation. These attributes may include, but are not limited to: cost, strength, durability, life cycle cost, marketability, appearance, packaging, size, serviceability, weight, manufacturability, ease of assembly, etc. The embodiments described herein that are described as less desirable than other embodiments or prior art implementations with respect to one or more characteristics are not outside the scope of the disclosure and may be desirable for particular applications. Additionally, the features of various implementing embodiments may be combined to form further embodiments of the invention.

What is claimed is:

1. A vehicle comprising:
at least one projector configured for displaying picture on at least one road surface region around said vehicle; and
a controller configured to
determine the features and positions of target road marking objects in a vehicle coordinate system;
generate a projection picture containing images for said road marking objects based on their features and positions in said vehicle coordinate system and based on the projection relationship between the position in projection picture frame and the position in said vehicle coordinate system; and
project said projection picture using said projector on target road surface region such that the road marking images sufficiently illuminate their target road marking objects.

2. The vehicle of claim 1, wherein the projector can be at least a laser projector with picture projected on road surface by laser beams and an optical projector with image project on road surface by light beams.

3. The vehicle of claim 1, wherein the road marking objects comprise at least one of road lane markings, road boundary, static and moving obstacles, road surface defects, driving processes and situations.

4. The vehicle of claim 1, wherein the controller is further configured to generate projection picture containing images for road markings that are obtained based on predicted future vehicle positions relatively to the present position of said vehicle coordinate system.

5. The vehicle of claim 1 further comprises at least one camera configured to capture picture of camera view covering a target road surface region around the vehicle; The controller of claim 1 is further configured to at least one of:
(i) recognize the features and positions of road marking objects in captured camera view picture;
(ii) compensate the camera orientation variations with consideration of vehicle body motions;
(iii) determine the features and positions of recognized road marking objects in said vehicle coordinate system based on their recognized features and positions in camera picture frame coordinate system and based on the perspective relationship between the position in camera picture frame and the position in said vehicle coordinate system; and
(iv) compensate the position displacements of recognized road marking objects in said vehicle coordinate system with considerations of vehicle motions and of the time difference between picture capture and picture projection.

6. The vehicle of claim 1, wherein the controller is further configured to generate projection picture containing images for road marking objects that are obtained based on at least one of:
(i) road marking objects that are interpolated based on other recognized road marking objects; and
(ii) road marking objects that are extrapolated based on other recognized road marking objects.

7. The vehicle of claim 1 further comprises at least one navigation device configured to obtain the vehicle's geographical position and to infer surrounding road marking objects; The controller of claim 1 is further configured to generate projection picture containing images of road markings that are used to illuminate the inferred road marking objects.

8. A method comprising:
determining the features and positions of target road marking objects in a vehicle coordinate system;
generating a projection picture containing images for said road marking objects based on their features and positions in said vehicle coordinate system and based on the projection relationship between the position in projection picture frame and the position in said vehicle coordinate system; and
projecting said projection picture using said projector on target road surface region such that the road marking images sufficiently illuminate their target road marking objects.

9. The method of claim 8 further comprises generating projection picture containing images for road markings that are obtained based on predicted future vehicle positions relatively to the present position of said vehicle coordinate system.

10. The method of claim 8 further comprises at least one of:
(i) recognizing the features and positions of road marking objects in captured camera view picture;
(ii) compensating the camera orientation variations with consideration of vehicle body motions;
(iii) determining the features and positions of recognized road marking objects in said vehicle coordinate system based on their recognized features and positions in camera picture frame coordinate system and based on the perspective relationship between the position in camera picture frame and the position in said vehicle coordinate system; and
(iv) compensating the position displacements of recognized road marking objects in said vehicle coordinate system with considerations of vehicle motions and of the time difference between picture capture and picture projection.

11. The method of claim 8 further comprises generating projection picture containing images of road markings that are obtained based on at least one of:
(i) road marking objects that are interpolated based on other recognized road marking objects; and
(ii) road marking objects that are extrapolated based on other recognized road marking objects.

12. The method of claim 8 further comprises inferring surrounding road marking objects based on obtained vehicle geographical position; and generating projection picture containing images of road markings that are used to illuminate the inferred road marking objects.

13. The method of claim 8 further comprises generating projection picture containing images of road markings using condition based patterns with respect to at least one of environmental lighting condition, weather condition, safety condition and road surface condition.

14. A road markings illumination system comprising:
at least one controller configured to
determine the features and positions of target road marking objects in a vehicle coordinate system;
generate a projection picture containing images for said road marking objects based on their features and positions in said vehicle coordinate system and based on the projection relationship between the position in projection picture frame and the position in said vehicle coordinate system; and
project said projection picture using said projector on target road surface region such that the road marking images sufficiently illuminate their target road marking objects.

15. The road markings illumination system of claim 14, wherein the controller is further configured to generate projection picture containing images for road markings that are obtained based on predicted future vehicle positions relatively to the present position of said vehicle coordinate system.

16. The road markings illumination system of claim 14 further comprises using at least one camera and to at least one of:
(i) recognize the features and positions of road marking objects in captured camera view picture;
(ii) compensate the camera orientation variations with consideration of vehicle body motions;
(iii) determine the features and positions of recognized road marking objects in said vehicle coordinate system based on their recognized features and positions in camera picture frame coordinate system and based on the perspective relationship between the position in camera picture frame and the position in said vehicle coordinate system; and
(iv) compensate the position displacements of recognized road marking objects in said vehicle coordinate system with considerations of vehicle dynamic states and of the time difference between picture capture and picture projection.

17. The road markings illumination system of claim 14, wherein the controller is further configured to generate projection picture containing images of road markings that are obtained based on at least one of:
(i) road marking objects that are interpolated based on other recognized road marking objects; and
(ii) road marking objects that are extrapolated based on other recognized road marking objects.

18. The road markings illumination system of claim 14 further comprises using at least one navigation device to obtain the vehicle geographical position and to infer surrounding road marking objects; The controller of claim 14 is further configured to generate projection picture containing images of road markings that are used to illuminate the inferred road marking objects.

19. The road markings illumination system of claim 14, wherein the controller is further configured to generate projection picture containing images of road markings using condition based patterns with respect to at least one of environmental lighting condition, weather condition, safety condition and road surface condition.
